(19) United States
(12) Patent Application Publication
(10) Pub. No.: US 2015/0277721 A1
(43) Pub. Date: Oct. 1, 2015

(54) PREVIEWING COMPRESSION INFORMATION

(71) Applicant: Brian Drewes, Brookline, MA (US)

(72) Inventor: Brian Drewes, Brookline, MA (US)

(21) Appl. No.: 14/229,195

(22) Filed: Mar. 28, 2014

(51) Int. Cl. G06F 3/0484; G06F 17/22

(52) U.S. Cl. CPC G06F 3/04847; G06F 17/2252

(57) ABSTRACT

Among other things, within a user interface of a host device or application with which a file that represents content can be captured or edited or both, enabling a user to preview information that would characterize the file if the file were compressed to reduce its size.

### BACKGROUND

This description relates to previewing compression information.

Graphical, audio, or video material, for example, that is to be delivered electronically to users, say, through the Internet, is typically acquired in formats that are of relatively high resolution and therefore in digital files that are relatively large. Because of bandwidth and storage constraints of communication channels and electronic devices, the graphical, audio or video files typically must be compressed (sometimes very significantly) during the process of creating media content to be distributed to users. Compressing the files tends to degrade the audio, graphical, or video presentation quality of the final media content. The creator of the media content normally reviews the quality of the final media content product to be distributed to make sure that the degradation of the audio, graphical, or video quality is no more than an acceptable amount. The checking of the quality of the audio, graphical, or video material that is yielded by the compressed file may need to be done many times during the process of creating the final media content product.

Typically, the process of assessing the impact of the compression requires a user to export and generate a new file that must then be reopened or reimported in order to be evaluated or compared to the original, native files.

### SUMMARY

In general, in an aspect, within a user interface of a host device or application with which a file that represents content can be captured or edited or both, a user can preview information that would characterize the file if the file were compressed to reduce its size.

Implementations may include one or a combination of two or more of the following features. A user can invoke a menu item within the user interface of the host device or application to be able to preview the information. The menu item is one that has been added to the user interface of the host device or application in connection with installation of software that enables the user to preview the information that would characterize the file if the file were compressed. Interactive controls are displayed to the user to enable the user to preview the information. The information that the user can preview includes an estimate of the size of the file if the file were compressed. The information that the user can preview includes a presentation of at least a portion of the content based on compression of the file. The user can preview the information at the same time as the user is viewing at least a portion of the user interface of the host device or application. The user can provide information that controls the compression of the file. The preset compression parameters are associated with a facility through which the compressed content is to be presented. The user can preview information that would characterize the file if the file were compressed to reduce its size, iteratively based on successive selections of different parameters for the compression. The user can preview the information that would characterize the file if the file were compressed to reduce its size in accordance with preset compression parameters. The preset compression parameters may or may not be determined by the user. To enable the user to preview the information, an application or a plug-in may be installed to the host device or application. To enable the user to preview the information, a service can be provided from a server. The content includes video. The content includes audio. The content includes images.

In general, in an aspect, a user, who is capturing or editing a digital media file using a content capturing or content editing application, can preview, within the content capturing or content editing application, information that would characterize the file if the file were compressed in accordance with a compression function. The previewed information includes the size of the file if it were compressed and a presentation of at least a portion of the file as it would be presented if the file were compressed. The compression function is configured according to compression parameters specified by the user of the content capturing or content editing application.

These and other aspects, features, and implementations, and combinations of them, may be expressed as apparatus, methods, methods of doing business, means or steps for performing functions, components, systems, program products, as computer systems, apparatus, and computer programs recorded on one or more computer storage devices, each configured to perform the actions of the methods, as a system of one or more computers configured to perform particular operations or actions by virtue of having software, firmware, hardware, or a combination of them installed on the system that in operation causes or cause the system to perform the actions, or one or more computer programs configured to perform particular operations or actions by virtue of including instructions that, when executed by data processing apparatus, cause the apparatus to perform the actions; and in other ways.

Implementations may achieve one or more of the following advantages. A user can determine how changes to a compression scheme affect the presentation of the content and can view actual changes to an image based on a selected compression scheme.

Other aspects, features, and advantages will be apparent from the description and the claims.

### DESCRIPTION

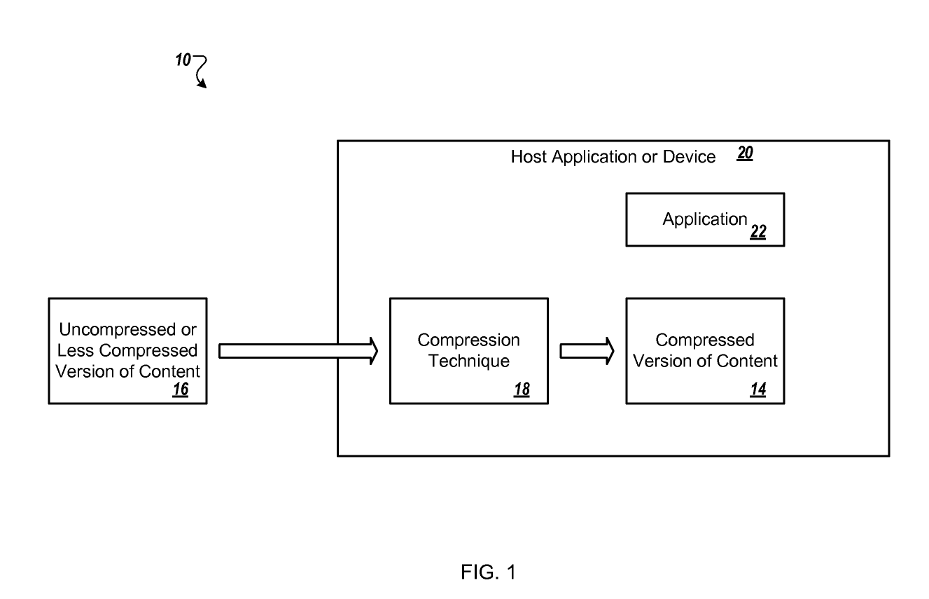

FIG. 1 is a block diagram of an example system that enables a user to easily, quickly, and repeatedly view and assess the presentation quality of a version of graphical, video, or audio content that has been compressed using a compression technique.

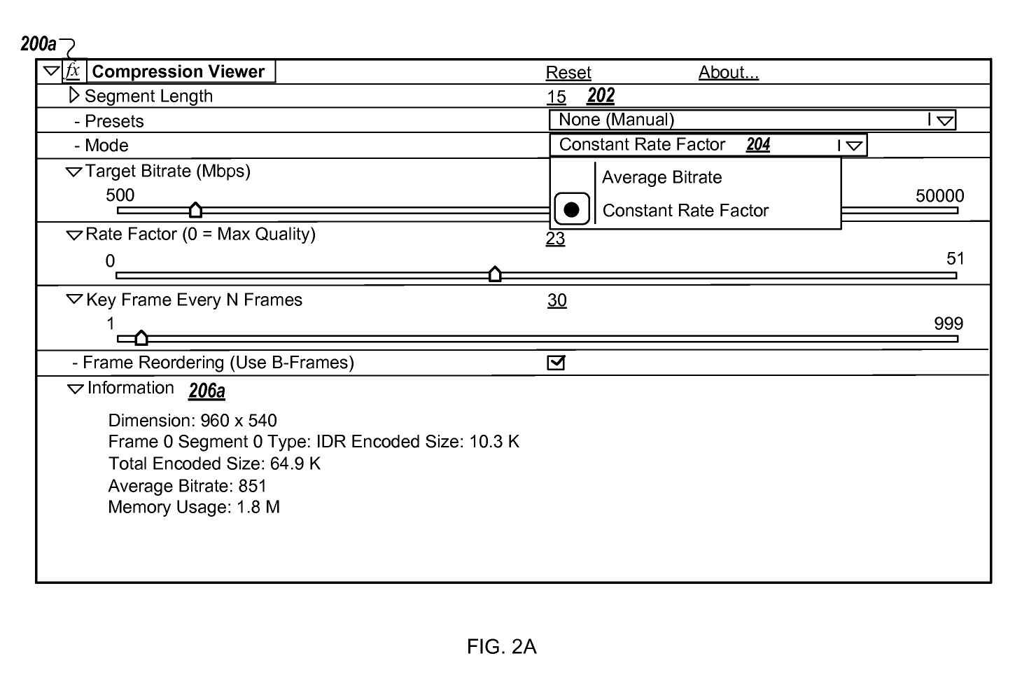

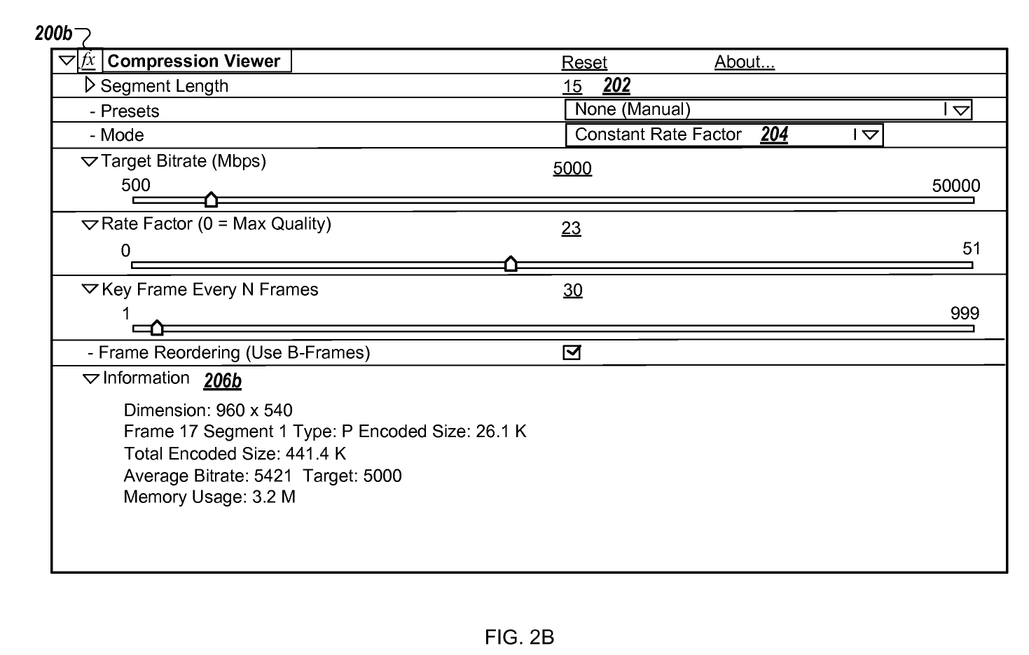

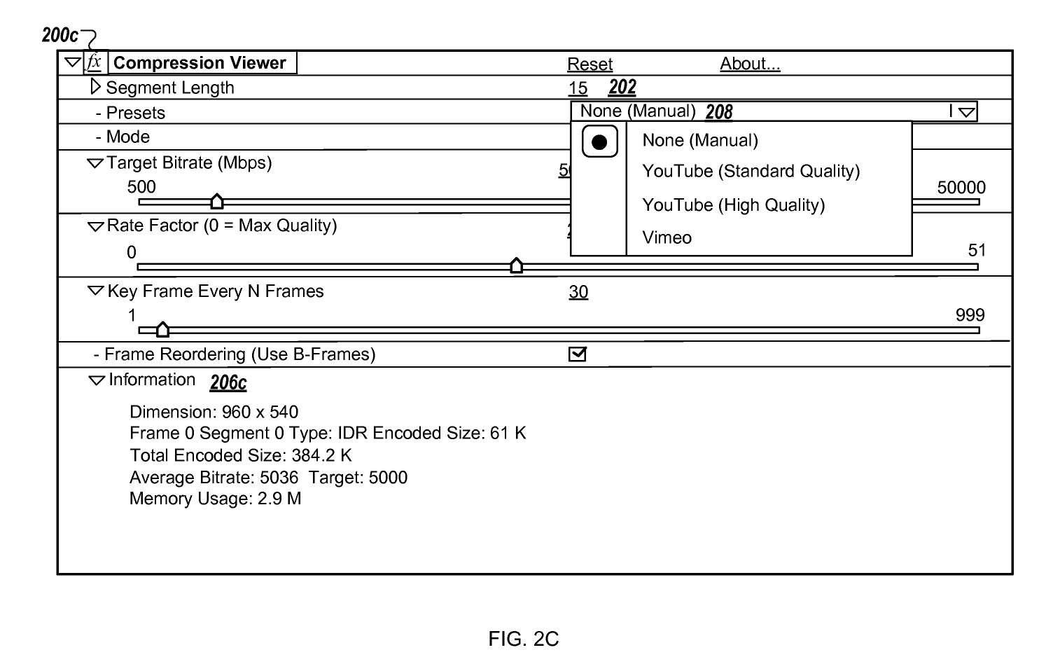

FIGS. 2A-C are an example of a user interface that presents compression preview information.

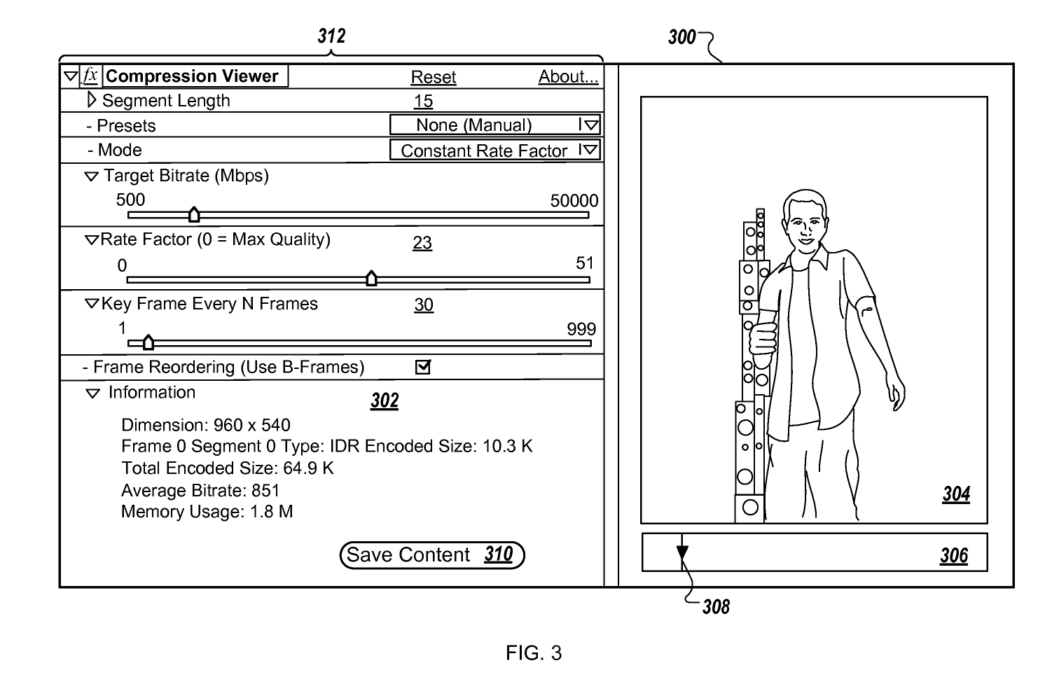

FIG. 3 is an example of a user interface including a compression summary and a content preview.

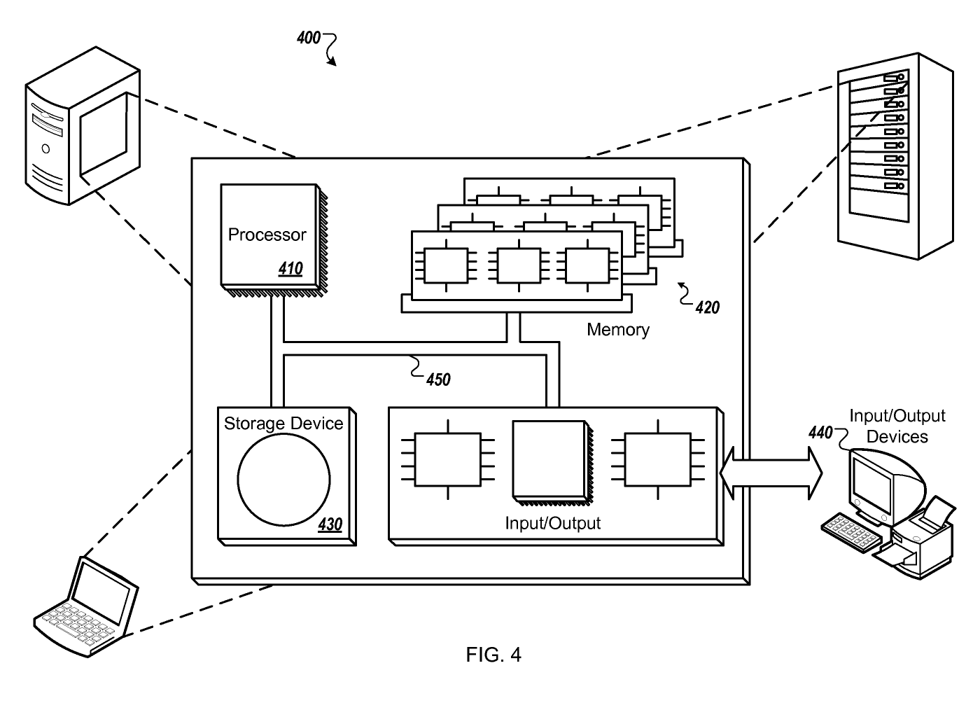

FIG. 4 is a block diagram of an example computer system.

As shown in FIG. 1, in examples of the system and techniques 10 that we describe here, a user can easily, quickly, and repeatedly view and assess the presentation quality of a version of graphical, video, or audio content that has been compressed 14 using a compression technique 18. The user can compare the presentation quality of the compressed content to the presentation quality of uncompressed or less compressed versions 16 to assess whether a degradation in presentation quality caused by the compression is acceptable in light of the intended use of the content, and whether the amount of digital data required to express the compressed version (for example, the file size) is suitable for the intended use.

A user having any level of experience or skill (from beginner to expert) can view and assess the quality of the content while working directly within a host application or device 20 that provides content editing and content creation features applicable to the content. In some implementations, the features and functions of the techniques and systems that we describe here are provided in a compiled software application 22 that is hardware-agnostic and is usable with any operating system (for example, Windows, Apple, Linux, iOS, or Android). The software application enhances the feature set of the host application or device, functioning as a plug-in for host graphics and editing programs or host audio and video acquisition devices running on workstations, mobile devices, cloud based hardware, or standalone cameras, for example. The software is useful in any content-acquisition, content-editing, and content-generation field of endeavor, in particular, for work product that will be distributed through internet publishing, email sharing, or social media channels or broadcast on television.

In some cases, the software application will operate as a plug-in or as a cooperating application for a wide variety of applications used in visual editing, visual graphics, 3-D development, computer-aided design, audio editing, and audio mixing. Examples include After Effects, Final Cut Pro, Avid, Cinema 4D, Premiere, Smoke/Flame, iMovie, Photoshop ProTools, AutoCAD, 3dStudioMax, and Nuke. In some implementations, the software application can be developed to function on mobile-based devices and standalone video or still cameras.

The function of this plug-in of application is to allow the user of these underlying host graphics and editing programs or audiovisual acquisition devices to assess and measure, using immediate observable feedback in the user-interface of the host application or device, the visible, auditory, and file-size impact of, for example, existing and popular image or audio compression techniques 18 that are generally employed to prepare the content for distribution to end users. The plug-in or application will port with digital still and motion cameras where a user may expect to wish to preview, assess, and measure the impact of the compression. The system and techniques also apply to mobile devices with which users may generate content and from which users may wish to publish without use of a workstation.

In some implementations, the features of the plug-in or application can be invoked from within the user interface of the host application or the host device by techniques that are typical for invoking such plug-ins. For example, the plug-in or application, when installed, may force a new menu item to be added to a drop-down menu, or an item can be added to a list of plug-ins that are accessible to the user, or a new menu item can be added to a context-sensitive pop-up menu that could be invoked by a right click of a mouse. In some implementations, the user uses the host program in the usual way. For example, in using After Effects to edit a video file, when a user decides to utilize the compression preview plug-in, she can simply create a new active layer in a timeline, then create a new effect by choosing this plug-in. Once this is chosen, a dialog window is then available (as shown in the figures). Any combination of those approaches could also be used. The plug-in or application can be invoked when a particular file is being used by or presented to a user or has otherwise been identified by the user, so that when the plug-in or application is invoked, the plug-in or application automatically provides functions and features with respect to that file. When the plug-in or application is invoked, a wide variety of features become available to the user.

For example, the compression preview plug-in or application can provide a user with compression preview information that indicates potential properties of a file that will result from particular compression settings for the file that a user may select. For instance, the plug-in or application may receive proposed compression settings from a user for a particular video file and provide the user with an estimated size of the file after compression. The plug-in or application can also present a sample video file that contains content from a portion of the particular video file that has been compressed using the proposed compression settings. In other words, at the time when a user is working with a file in a host application or on a host device, the user can immediately, and within the host application or device, view the impact of compression of the file that is performed based on user selection of parameters that govern the compression.

The process can be repeated iteratively and quickly to enable the user to gauge the impact of various compression settings. For this purpose, in some examples, the plug-in may receive from the user one or more adjustments to the compression settings and provide the user with an updated estimated file size and a view of an updated sample video file. The user may compare the estimated file sizes and presentations of the sample video files, e.g., when the plug-in presents multiple samples side-by-side, to determine which compression settings to use for the particular video file given the intended use.

The compression preview plug-in or application may allow a user to select a compression scheme for still images, audio files, and/or video files and may offer one or more selectable preset compression schemes. For instance, a compression preview plug-in or an application may include a preset compression scheme for a particular website, e.g., a social media site, and the user may select the preset compression scheme for an audio file that she will later upload to the particular website. Presets may be provided as part of the compression preview plug-in or application, or they may be added by a user for later use.

A mobile device, e.g., a smart phone, or a camera, or a server may execute the compression preview application or the plug-in and the user may use the compression preview application or the plug-in to analyze a raw, uncompressed file or a compressed file. When the compression preview application or plug-in is installed and executes on a server, the compression preview application or plug-in may analyze a file stored on the same server, another server, e.g., that hosts audio or video files, or a client device, e.g., a laptop or a smart phone.

A copy of the same plug-in or application may be installed for use on multiple different operating systems and in multiple different host applications or devices to provide the host applications or devices with the functionality to present compression preview information to a user. For instance, the same plug-in may be installed in the same host application or device for use with multiple different operating systems and provide the compression preview functionality for the host application or device across all of the operating systems. Another plug-in, specific to a different host application or device, may provide the compression preview functionality for the different host application or device across multiple operating systems.

FIG. 2A is an example of a user interface 200a that presents compression preview information. The user interface 200a may be part of a compression preview application or a plug-in that allows a user to adjust a compression scheme for a file, e.g., prior to generation of a compressed version of the entire file. The user interface shown in FIG. 2A may be in the form of a window that opens when the compression preview plug-in or application is invoked by one of the techniques mentioned above. The window could replace the window that the user had been viewing, could be a pop-up window overlaid on the window that the user had been viewing, or could be presented in other ways.

The user interface 200a includes multiple options that allow a user to select a preset compression scheme, described in more detail below, or to create a compression scheme for a file while viewing the information that indicates potential changes that will occur to a compressed file based on the currently selected compression scheme. The example shown in FIG. 2A relates to a video file; similar windows could be displayed with appropriate fields for other kinds of content files, such as audio or images.

The user interface 200a includes a segment length option 202 that allows a user to specify the number of frames included in a segment which the compression preview plug-in or application analyzes to determine the compression preview information. For example, when the compression preview plug-in or application receives a request for a compression preview of a video file, the compression preview plug-in or application will analyze a particular segment of the video file, present a compressed version of the particular segment to the user, e.g., that the user may watch within the plug-in window, and estimate a file size for the video file if the video file is compressed using the currently selected compression scheme.

The user interface 200a includes a bitrate mode option 204 for the current compression scheme. Depending on the mode selected, the user interface 200a may allow a user to adjust one or more additional compression settings, such as a target bitrate, a bitrate factor, a key frame every N frames, and a frame reordering setting. Some examples of modes for a compression scheme include average bitrate and constant rate factor.

A compression summary 206a, included in the user interface 200a, presents information about the selected compression scheme and estimated summary information that provides details about encoding a file with the currently selected compression scheme. For instance, the compression preview plug-in or application determines the compression summary 206a using the analysis of one or more segments from a video file identified by the user. As the compression preview plug-in or application analyzes more segments of the video file, the compression preview plug-in or application updates the compression summary 206a using the results of the additional analysis. When the compression preview plug-in or application determines the compression summary 206a using data from the analysis of multiple segments from the video file, the compression summary 206a may be more accurate than a compression summary determined from the analysis of fewer segments of the video file, e.g., one segment.

The compression preview plug-in or application may present the compression summary 206a automatically, e.g., in response to a change to one of the compression settings, or in response to selection of a preview now option, e.g., a button included in the user interface 200a. When the compression preview plug-in or application receives data representing user selection of the preview now button, the compression preview plug-in or application compresses the one or more segments of the video file, e.g., identified by the user or automatically by the compression preview plug-in or application, and populates the compression summary 206a.

The compression preview plug-in or application may receive input from the user that identifies (as a source file for the compression summary) a raw, uncompressed file, e.g., still image, audio file, or video file, or may receive input that identifies a file that had been previously compressed. In some implementations, the compression preview plug-in or application may determine the compression settings or ranges to present in the user interface 200a using the type of file identified by the user or some of the properties of the file. For instance, when the compression preview plug-in or application receives identification of a raw file, the user interface 200a may include a larger range of selectable compression options, e.g., bitrates and/or resolutions, than when the compression preview plug-in or application receives identification of a file that had been previously compressed.

The file identified by the user may contain content created by the user, e.g., using a drafting application, or captured using a device, e.g., a microphone and/or a camera. The compression preview plug-in or application may be installed on the device that captured the content, e.g., a camera, or on another device, e.g., a computer to which the images, audio files, or video files are uploaded.

FIG. 2B shows another example of a user interface 200b with a bitrate mode selection of average bitrate. A compression summary 206b shows information about the segment the compression preview plug-in or application analyzed to determine the compression summary 206b, including the particular segment of a specific file, e.g., identified by a user. For instance, the compression summary 206b indicates that the compression preview plug-in or application compressed segment 1 of the specific file, that frame 17 of segment 1 was processed using periodic averaging during the compression processes, and that the size of the compressed segment is 26.1 kilobytes.

Using the compression of the particular segment of the specific file, the compression preview plug-in or application estimates that a compressed size of the specific file, using a selected compression scheme, will be 441.4 kilobytes and that the average bitrate will be 5421 bits per second. The compression preview plug-in or application may receive additional input from the user indicating that the compression preview plug-in or application should compress additional segments of the specific file, using the segment length value and input from the user identifying a portion of the specific file to analyze, and update the compression summary accordingly.

The compression preview plug-in or application caches the results of the compression, e.g., the compressed segments, and presents the compressed segments to the user (for example, plays back the video segments to the user for consideration). The caching of the compressed segments allows the user to interact with different portions of the specific file without recompression of a previously compressed segment.

For instance, the compression preview plug-in or application may use a hash to determine whether a segment selected by a user has changed since the segment was last compressed. If the segment has not changed, the compression preview plug-in or application presents the cached version of the segment to the user. If the segment has changed, or if the user changed one of the settings of the current compression scheme, the compression preview plug-in or application generates a new compressed version of the segment. The compression preview plug-in or application may use any appropriate method to determine whether a user modified a segment, e.g., the audio or video included in the segment, or a compression scheme has changed.

In some examples, a user may use the host application or device to edit a file, e.g., in response to or based on the data presented in the compression summary 206b or based on the preview presented by the compression preview plug-in or application. For instance, the user may change a color of a portion of a still image or lower a pixel resolution of an image to decrease an estimated file size presented in the compression summary 206b.

In order to approximate the final result that will be achieved when the file is compressed and ready for distribution, in the most realistic way possible, the compression preview plug-in or application uses available and popular compression codecs. These codecs generally evaluate the entire frame range before returning final results. In some implementations, this may be undesirable as little time is saved. The frame range functionality within the compression preview plug-in or application allows the user to define the granularity of the number of frames analyzed. In general, the more frames chosen, the more accurate the result though the longer the process.

FIG. 2C shows an example of a user interface 200c that displays compression scheme presets. The compression preview plug-in or application may include compression scheme presets 208 for popular compression schemes, such as compression schemes used by particular websites, e.g., social media sites. A user may select one of the compression scheme presets 208 for a file prior to uploading the file to the particular website.

The user interface 200c allows a user to create custom compression scheme presets. For instance, the user may adjust the compression settings in the user interface 200c, and select a save preset option. The user may then use the saved compression scheme preset in the compression preview plug-in or application at a later time.

In some implementations, a user may select the same custom compression scheme preset in multiple different host applications or on multiple different devices. For instance, when the user interface 200c is part of a plug-in, a custom compression scheme preset may be available in all applications for which the plug-in is enabled, e.g., on a single device. For example, the custom compression scheme presets can be synchronized through the cloud among multiple devices and applications

A user may be able to create an account that provides access to a custom compression scheme preset on multiple devices. For example, the account may be specific to a particular application, e.g., that includes the user interface 200c, or a plug-in and provide the user with access to the custom compression scheme preset on multiple different devices, e.g., a smart phone, a camera, and a desktop or tablet.

When the compression preview plug-in or application detects user selection of a presets option, the compression preview plug-in or application automatically adjusts the compression settings presented in the user interface 200c. Some of the presets may allow a user to adjust the compression settings, e.g., custom presets, and some of the presets may prevent user adjustment of the compression settings, e.g., a preset for a particular website.

FIG. 3 is an example of a user interface 300 including a compression summary 302 and a content preview 304. The content preview 304 provides a user with full resolution images or video using the currently selected compression scheme or content from a non-compressed file. For instance, when a host application or device initially presents the user interface 300, the host application or device may receive input from a user that identifies a particular file, e.g., in a raw or previously compressed format. In response to the input, the compression preview plug-in or application presents an uncompressed preview of the particular file, e.g., a first frame from a video, in the content preview 304.

The user interface 300 may include a timeline 306 that allows a user to adjust the content presented in the content preview 304. In response to movement of a slider 308 in the timeline 306, the compression preview plug-in or application presents a corresponding portion of the particular file.

The compression preview plug-in or application receives input from the user identifying a compression scheme, e.g., a preset compression scheme or a manually entered compression scheme, and a selection of a preview now button. The compression preview plug-in or application then generates a compressed segment by compressing a portion of the particular file. The beginning of the segment may be predetermined by the compression preview plug-in or application, e.g., the beginning of the file, or specified by a user, e.g., using a position of the slider 308.

The compression preview plug-in or application presents the compressed segment to the user, e.g., in the content preview for a video segment or a still image, and/or using speakers for an audio segment or a video segment. In some examples, the compression preview plug-in or application may automatically present updated content in the content preview 304 without user selection of a preview now button, e.g., when the particular file contains data representing a still image.

The compression preview plug-in or application may receive input identifying another segment selected by the user, e.g., using the slider 308. In response, the compression preview plug-in or application may automatically compress another segment identified by the input. The beginning of the other segment may be specified by the input, e.g., the location of the slider 308 in the timeline 306. In some examples, the center of the other segment may be specified by the input, or the compression preview plug-in or application may compress multiple segments in response to the input.

The compression preview plug-in or application may receive selection of a save content option 310 that compresses an entire file identified by a user with the currently selected compression scheme. In response to receipt of data indicating the selection of the save content option 310, the compression preview plug-in or application may present a user with a menu of file types for the compressed file. In some implementations, the file types presented in the menu may include all files types of the appropriate format, e.g., video file types for video files, or only the file types that are compatible with the currently selected compression scheme, e.g., shown in the user interface 300. For instance, if only one file type supports the currently selected compression scheme, the compression preview plug-in or application may automatically select the one file type and present the user with a prompt to specify a name for the newly generated compressed file. The file types include file types supported by the compression application or a host application or device, in the case of a compression plug-in.

In some implementations, installation of a compression plug-in adds a compression option to a content effects menu. When the host application determines that a user selected the compression option, the host application presents a compression menu 312, described above with reference to FIGS. 2A-C.

In some implementations, the user interface 300 may include an interface element that indicates which portions of the particular file have been converted using the currently selected compression scheme. A timeline, e.g., the timeline 306 or another timeline slider, may indicate which portions of the particular file the compression preview plug-in or application compressed using the currently selected compression scheme. In some examples, the user interface 300 may include multiple separate interface elements that allow a user to select between different compression schemes and view portions of the particular file compressed using the corresponding compression scheme, e.g., to compare visual and/or audible differences between the compression schemes. The host compression preview plug-in or application may update the compression menu 312 with the corresponding compression settings when switching between different compression schemes in addition to presenting content compressed using the corresponding compression scheme.

For instance, the compression preview plug-in or application may compress a single segment of the particular file using two different compression schemes and present two timeline sliders, one for each of the compression schemes. Upon receipt of a selection of one of the timeline sliders, the compression preview plug-in or application presents the corresponding compressed segment to the user, e.g., and updates the compression menu 312 accordingly.

In order to enhance the speed with which results are returned the plug-in allows for multi-threading, thus using the full capacity of the workstation more effectively and providing an enhanced user-experience.

Many host applications return quick results of scrubbing through timelines by returning lower-resolution images to the user interface. In some implementations, this may be problematic as inaccurate results are returned if the source image is of low-resolution. For accurate results the compression preview plug-in or application must return results from a full resolution image. Thus the compression preview plug-in or application may ignore the lower-resolution images, and instead always process a full-resolution image, caching the result of that processing and also returning to the host application the requested file-size as determined by the host applications software instructions, again encouraging faster scrubbing results.

The compression preview plug-in or application software can be used to export an active timeline and thus bypass the host applications' export features. This can save considerable effort, as all previously tested presets will not need to be re-entered from within the host application's own software UI. Additionally, the multi-threading and caching functionalities may result in faster compression that the host application's existing feature set.

The custom-defined presets are user-based and thus will be accessible between multiple underlying graphics or editing programs the user owns and has licensed the compression preview plug-in for.

FIG. 4 is a block diagram of an example computer system 400. For example, referring to FIG. 2A, the client device or server, executing the application or plug-in, could be an example of the system 400 described here. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In some implementations, the processor 410 is a single-threaded processor. In some implementations, the processor 410 is a multi-threaded processor. In some implementations, the processor 410 is a quantum computer. The processor 410 is capable of processing instructions stored in the memory 420 or on the storage device 430. The processor 410 may execute operations such as the presentation of the user interfaces 100a-c (FIGS. 2A-C).

The memory 420 stores information within the system 400. In some implementations, the memory 420 is a computer-readable medium. In some implementations, the memory 420 is a volatile memory unit. In some implementations, the memory 420 is a non-volatile memory unit.

The storage device 430 is capable of providing mass storage for the system 400. In some implementations, the storage device 430 is a computer-readable medium. In various different implementations, the storage device 430 can include, for example, a hard disk device, an optical disk device, a solid-date drive, a flash drive, magnetic tape, or some other large capacity storage device. In some implementations, the storage device 430 may be a cloud storage device, e.g., a logical storage device including multiple physical storage devices distributed on a network and accessed using a network. In some examples, the storage device may store long-term data, such as the present compression schemes, as well as compressed and uncompressed files. The input/output device 440 provides input/output operations for the system 400. In some implementations, the input/output device 440 can include one or more of a network interface devices, e.g., an Ethernet card, a serial communication device, e.g., an RS-232 port, and/or a wireless interface device, e.g., an 802.11 card, a 3G wireless modem, a 4G wireless modem, etc. A network interface device allows the system 400 to communicate, for example, transmit and receive data such as a compressed or uncompressed file, e.g., from a client device to a server. In some implementations, the input/output device can include driver devices configured to receive input data and send output data to other input/output devices, e.g., keyboard, printer and display devices 460. In some implementations, mobile computing devices, mobile communication devices, and other devices can be used.

A server can be realized by instructions that upon execution cause one or more processing devices to carry out the processes and functions described above, for example, sending and receiving compressed and uncompressed files. Such instructions can include, for example, interpreted instructions such as script instructions, or executable code, or other instructions stored in a computer readable medium. A compression preview application can be distributively implemented over a network, such as a server farm, or a set of widely distributed servers or can be implemented in a single virtual device that includes multiple distributed devices that operate in coordination with one another. For example, one of the devices can control the other devices, or the devices may operate under a set of coordinated rules or protocols, or the devices may be coordinated in another fashion. The coordinated operation of the multiple distributed devices presents the appearance of operating as a single device.

Although an example processing system has been described in FIG. 4, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification, such as software for creating and maintaining compression schemes, can be implemented as one or more computer program products, i.e., one or more modules of computer program instructions encoded on a tangible program carrier, for example a computer-readable medium, for execution by, or to control the operation of, a processing system. The computer readable medium can be a machine readable storage device, a machine readable storage substrate, a memory device, a composition of matter effecting a machine readable propagated signal, or a combination of one or more of them.

The term “system” may encompass all apparatus, devices, and machines for processing data, including by way of example a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. Sometimes a server is a general purpose computer, and sometimes it is a custom-tailored special purpose electronic device, and sometimes it is a combination of these things.

Implementations can include a back end component, e.g., a data server, or a middleware component, e.g., an application server, or a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

Certain features that are described above in the context of separate implementations can also be implemented in combination in a single implementation. Conversely, features that are described in the context of a single implementation can be implemented in multiple implementations separately or in any sub-combinations.

The order in which operations are performed as described above can be altered. In certain circumstances, multitasking and parallel processing may be advantageous. The separation of system components in the implementations described above should not be understood as requiring such separation.

Other implementations are within the scope of the following claims.

1. A method comprising
within a user interface of a host device or application with which a file that represents content can be captured or edited or both,
enabling a user to preview information that would characterize the file if the file were compressed to reduce its size.

2. The method of claim 1 in which enabling a user to preview information comprises enabling the user to invoke a menu item within the user interface of the host device or application.

3. The method of claim 2 in which the menu item has been added to the user interface of the host device or application in connection with installation of software that enables the user to preview the information that would characterize the file if the file were compressed.

4. The method of claim 1 in which enabling a user to preview information comprises displaying interactive controls to the user.

5. The method of claim 1 in which the information that the user can preview comprises an estimate of the size of the file if the file were compressed.

6. The method of claim 1 in which the information that the user can preview comprises a presentation of at least a portion of the content based on compression of the file.

7. The method of claim 1 in which the user can preview the information at the same time as the user is viewing at least a portion of the user interface of the host device or application.

8. The method of claim 1 comprising enabling the user to provide information that controls the compression of the file.

9. The method of claim 1 in which the user is enabled to preview information that would characterize the file if the file were compressed to reduce its size, iteratively in response to successive selections of different parameters for the compression.

10. The method of claim 1 in which the user can preview the information that would characterize the file if the file were compressed to reduce its size in accordance with preset compression parameters.

11. The method of claim 10 in which the preset compression parameters are not determined by the user.

12. The method of claim 10 in which the preset compression parameters are determined by the user.

13. The method of claim 1 in which enabling the user to preview the information comprises installing a plug-in to the host device or application.

14. The method of claim 1 in which enabling the user to preview the information comprises installing an application on the host device or on an operating system associated with the application.

15. The method of claim 1 in which enabling the user to preview the information comprises providing a service from a server.

16. The method of claim 1 in which the content comprises video.

17. The method of claim 1 in which the content comprises audio.

18. The method of claim 1 in which the content comprises images.

19. A method comprising
enabling a user, who is capturing or editing a digital media file using a content capturing or content editing application, to preview, within the content capturing or content editing application, information that would characterize the file if the file were compressed in accordance with a compression function, the previewed information including the size of the file if it were compressed and a presentation of at least a portion of the file as it would be presented if the file were compressed, the compression function being configured according to compression parameters specified by the user of the content capturing or content editing application.
